(19) United States
(12) Patent Application Publication
(10) Pub. No.: US 2006/0026508 A1
(43) Pub. Date: Feb. 2, 2006

(54) Document creation system and related methods

(76) Inventors: Helen Balinsky, Cardiff (GB); Brian Atkins, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/190,436

(22) Filed: Jul. 27, 2005

(30) Foreign Application Priority Data
Jul. 27, 2004 (GB) 0416642.7
Jan. 31, 2005 (GB) 0501884.1

(51) Int. Cl. G06F 17/21; G06F 17/24

(52) U.S. Cl. 715/517; 715/510

(57) ABSTRACT

A method of laying out a plurality of content-items on an electronically stored document which provides an area onto which the content-items are to be placed, the method comprising: positioning within the area any content-items for which there is a requirement for placement at a predetermined location within the area; generating one or more lines within the remaining area once any such fixed content-items have been placed in the area; creating one or more sub-areas to form a set of sub-areas from the lines that have been generated within the remaining area; assessing whether the set of sub-areas is a suitable solution to laying out the content-items on the document; and repeating steps c. and d. until a suitable layout has been achieved.

This invention relates to a document creation system and related methods. In particular, but not exclusively, the invention relates to customisation of printed documents.

With the advent of databases holding information about customers', clients', etc. (hereinafter referred to as customer) preferences, purchases, past actions, and the like, it has become possible to generate targeted communications that are targeted specifically to a particular customer based upon the data held in the database. Such databases may be exemplified by so-called supermarket loyalty schemes. However, the skilled person will appreciate that such schemes are only one such example.

Such targeted communications may be thought of as more high value than communications that are sent en masse to a plurality of customers since they are targeted to a particular customer and are therefore perhaps more likely to be well received. However, in order that a targeted communication is well received it must be laid out correctly.

It will be appreciated that databases may comprise many thousands (and even tens or hundreds of thousands) of customers. It would be impossible to check, manually, that targeted communications sent to such a number of people conform to accepted presentation rules within reasonable time scales. As such the process should be advantageously performed automatically.

Readers of the communications are exposed to a large number of professionally published materials and consequently, have strong expectations of high quality documents. Thus, readers generally have an expectation that any communications they receive will be of a high quality.

Prior solutions are based on stochastic searches in unrestricted spaces. The objectives of these prior solutions tended to be the minimisation of wasted (i.e. empty) area and/or the elimination of overlaps between different content-items. Such prior art does not address some of the concerns that arise in publishing; empty area is a rest area for the eyes of a reader and publications generally have an amount of such empty area. A typical holiday brochure may have roughly 20% empty area. The distribution of such empty area and its pattern is perhaps more relevant than the amount of such area.

Additional considerations arise if the targeted communication is a printed page such as a catalogue, pamphlet, letter, or the like. Unlike electronic documents such as web pages, emails, etc., a printed page has hard boundaries (i.e. no scrollbars) and for targeted communications continuation on the next page may generally be avoided. Content-items (such as text and/or photographs) are almost never split across different pages partially because of their relatively small size and also due to aesthetical principles, like for example, it is inconvenient to have photo of a sale item on one page and its description on the other.

According to a first aspect of the invention there is provided a method of laying out a plurality of content-items on an electronically stored document which provides an area onto which the content-items are to be placed, the method comprising:
a. positioning within the area any content-items for which there is a requirement for placement at a predetermined location within the area;
b. generating one or more lines within the remaining area once any such fixed content-items have been placed in the area;
c. creating at least one set of sub-areas from the lines that have been generated within the remaining area;
d. assessing whether at least one set of sub-areas is a suitable solution to laying out the content-items on the document; and
e. repeating steps c. and d. until a suitable layout has been achieved.

According to a second aspect of the invention there is provided a document layout system arranged to layout a plurality of content-items on an electronically stored document having an area on which information should be displayed comprising a content-item supply means arranged to provide content-items containing displayable information, a positioning means arranged to position any content-items for which there is a requirement for placement at a predetermined fixed location within the area, a line generator arranged to generate one or more lines within the remaining area once any fixed content items have been placed in the area, a sub-area creator arranged to create at least one set of sub-areas from the lines generated by the line generator and an assessment means arranged to assess whether at least one set of sub-areas is a suitable solution to laying out the content-items on the document.

According to a third aspect of the invention there is provided a program for laying out a plurality of content-items on an electronically stored document which provides an area onto which the content-items are to be placed, the program comprising code for:
a. positioning within the area any content-items for which there is a requirement for placement at a predetermined location within the area;
b. generating one or more lines within the remaining area once any such fixed content-items have been placed in the area;
c. creating at least one set of sub-areas from the lines that have been generated within the remaining area;
d. assessing whether at least one set of sub-areas is a suitable solution to laying out the content-items on the document; and
e. repeating steps c. and d. until a suitable layout has been achieved.

According to a fourth aspect of the invention there is provided a machine readable medium containing instructions which when read onto a computer cause that computer to perform the method of the first aspect of the invention.

According to a fifth aspect of the invention there is provided a machine readable medium containing instructions which when read onto a computer cause that computer to function as the document creation system of the second aspect of the invention.

According to a sixth aspect of the invention there is provided a machine readable medium containing instructions which provide the program of the third aspect of the invention.

The machine readable medium of any of the above aspects of the invention may be any one or more of the following: a floppy disk; a CDROM/RAM; a DVD ROM/RAM (including +R/RW, −R/RW); any form of magneto optical disk; a hard drive; a memory; a transmitted signal (including an internet download, file transfer, or the like); a wire; or any other form of medium.

An embodiment of the present invention is now described, by way of example only and with reference to the accompanying figures of which:

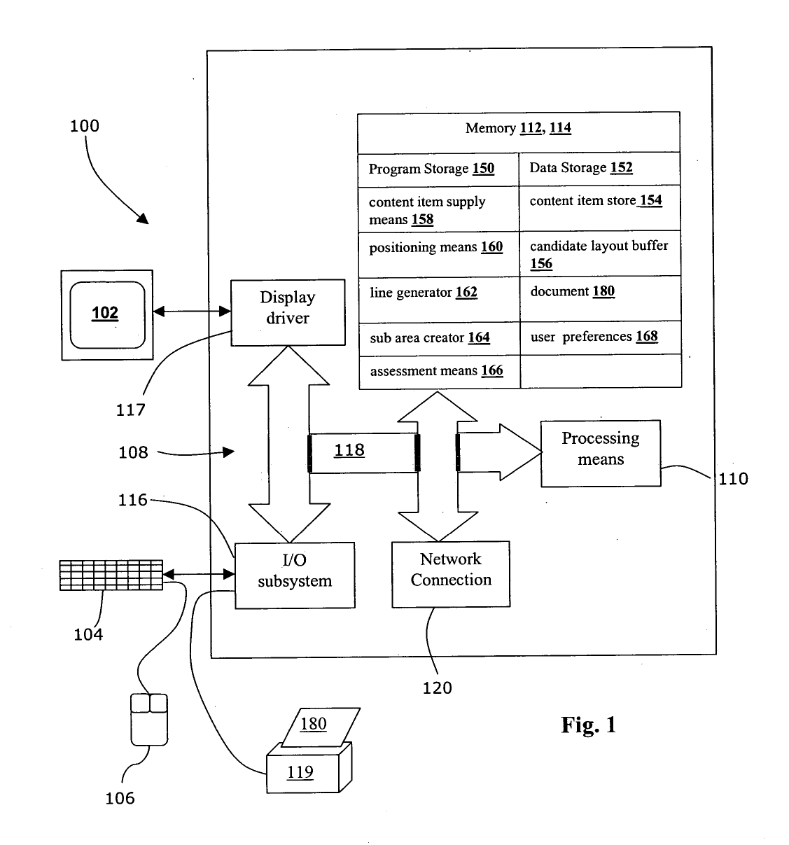

FIG. 1 schematically shows a computer arranged to provide one embodiment of the present invention;

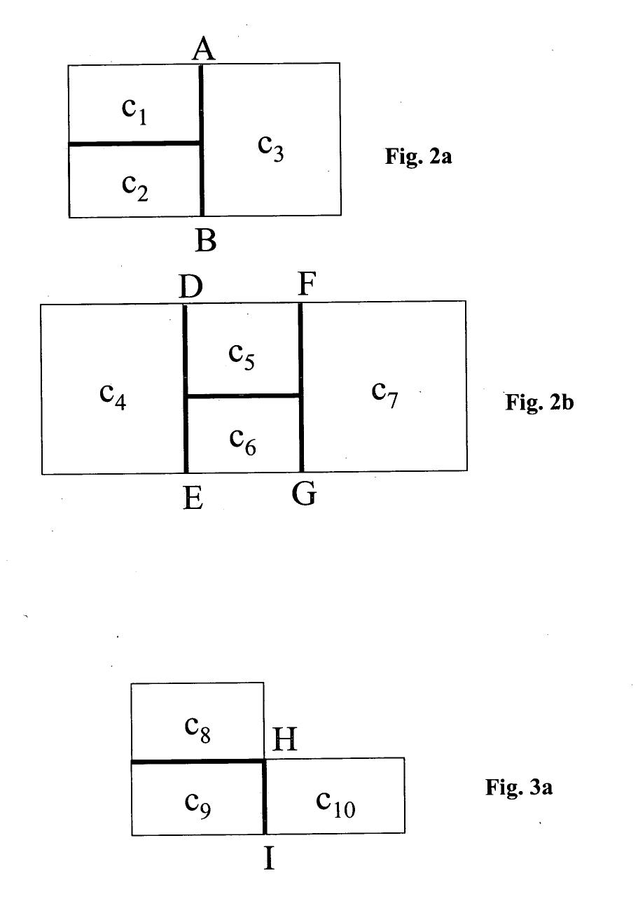

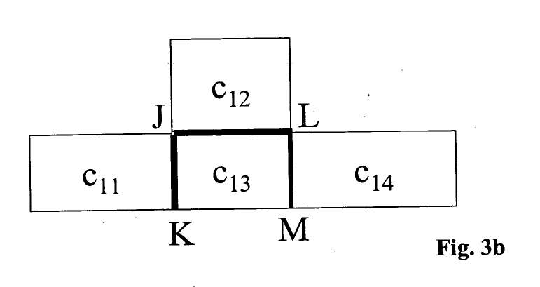

FIGS. 2 and 3 show examples of how cells of a grid may be joined to one another;

FIG. 4 shows five cells of a grid which may be joined to one another;

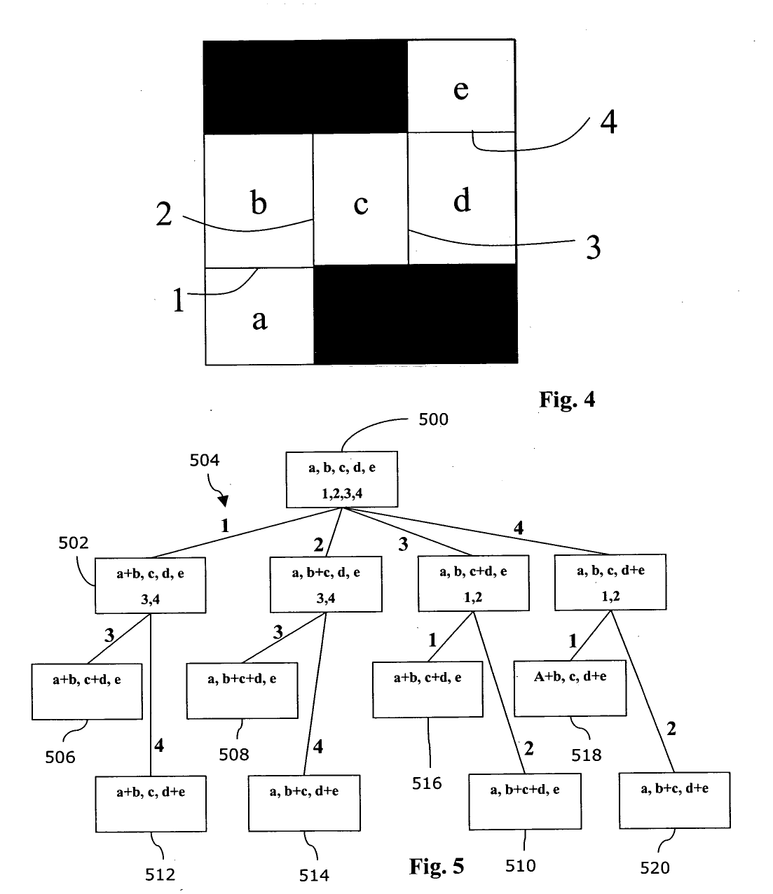

FIG. 5 shows a tree for the example of FIG. 4 which is used by embodiments of the invention for determining which cells should be joined;

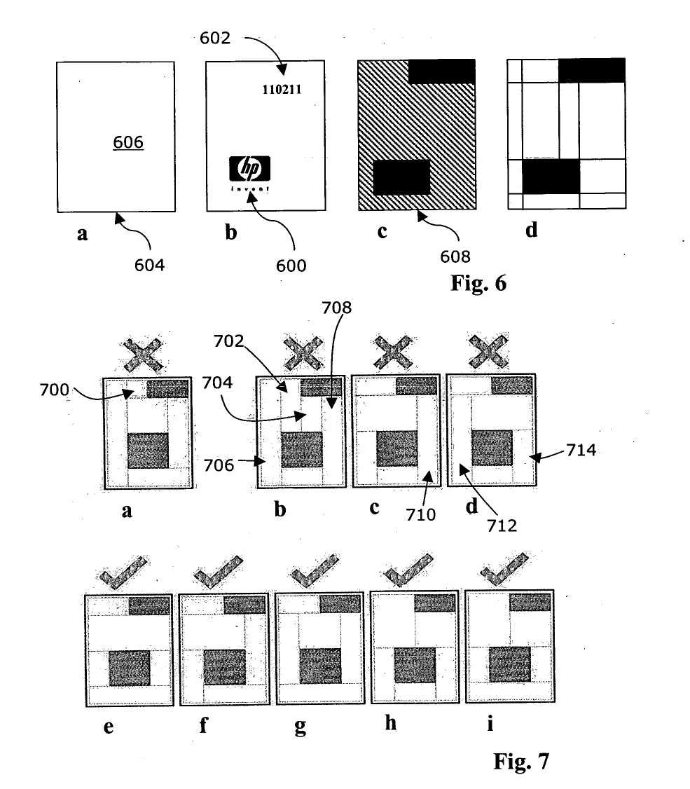

FIG. 6 shows how a document may be developed by embodiments of the invention;

FIG. 7 shows examples of containers that may be produced by embodiments of the invention from the example of FIG. 6; and

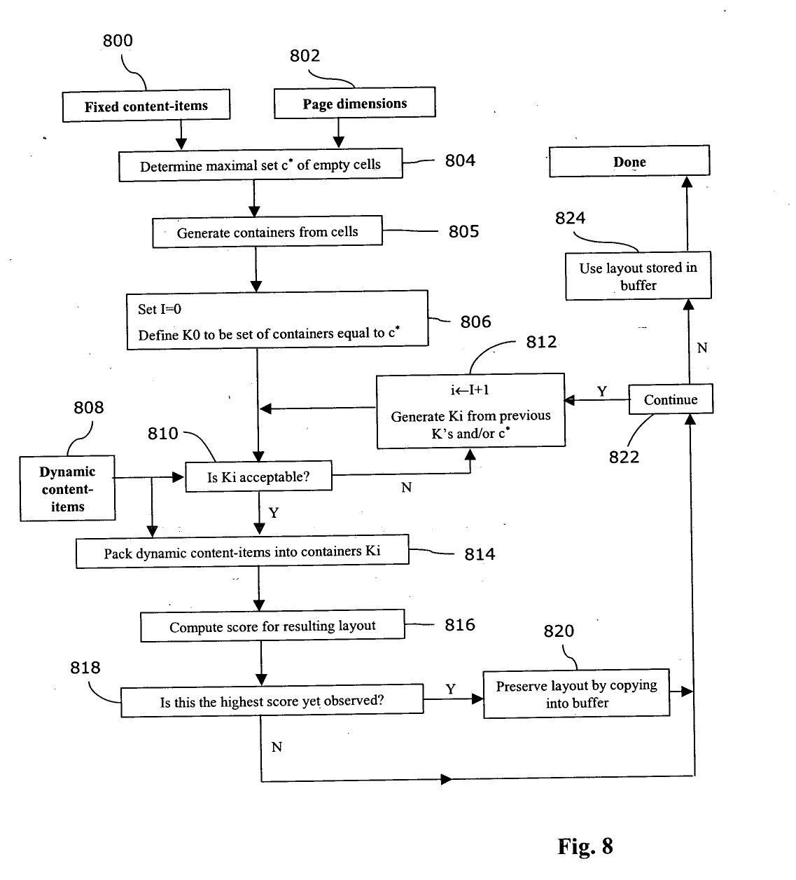

FIG. 8 shows a flow chart from providing an embodiment of the present invention.

This particular invention may be used to automatically lay out communications, which are generally, but not exclusively, printed documents having a displayable area. For conciseness this method will hereinafter be described in relation to the creation of printed documents although it has wider applicability. The method may for example be applied to electronic documents such as emails, web pages, Adobe PDF files and the like. Generally, the documents will be stored in an electronic form in an electronic memory.

The production of a document is a time consuming task which is made more time consuming if the document is to be customised to a specified reader. The document may for example be a holiday brochure, a store magazine, a catalogue, or the like, in which the contents is tailored according to the reader to whom the document will be sent or otherwise addressed.

FIG. 1 shows a computer 100 arranged to accept data and to process that data. The computer 100 comprises a display means 102, in this case an LCD (Liquid Crystal Display) monitor, a keyboard 104, a mouse 106 and processing circuitry 108. It will be appreciated that other display means such as LEP (Light Emitting Polymer), CRT (Cathode Ray Tube) displays, projectors, televisions and the like may be equally possible.

The processing circuitry 108 comprises a processing means 110, a hard drive 112 (containing a store of data), memory 114 (RAM and ROM), an I/O subsystem 116 and a display driver 117 which all communicate with one another, as is known in the art, via a system bus 118. The processing means 110 (often referred to as a processor) typically comprises at least one INTEL™ PENTIUM™ series processor, (although it is of course possible for other processors to be used) and performs calculations on data. The other processors may include processors such as the AMD™ ATHLON™, POWERPC™, DIGITAL™ ALPHA™, and the like.

The hard drive 112 is used as mass storage for programs and other data and may be used as a virtual memory. Use of the memory 114 is described in greater detail below.

The keyboard 104 and the mouse 106 provide input means to the processing means 110. Other devices such as CDROMS, DVD ROMS, scanners, etc. could be coupled to the system bus 118 and allow for storage of data, communication with other computers over a network, etc.

The I/O (Input/Output) subsystem 116 is arranged to receive inputs from the keyboard 104 and from the processing means 110 and may allow communication from other external and/or internal devices. The display driver 117 allows the processing means 110 to display information on the display 102.

The processing circuitry 108 further comprises a transmitting/receiving means 120, which is arranged to allow the processing circuitry 108 to communicate with a network. The transmitting/receiving means 120 also communicates with the processing circuitry 108 via the bus 118.

The processing circuitry 108 could have the architecture known as a PC, originally based on the IBM™ specification, but could equally have other architectures. The processing circuitry 108 may be an APPLE™, or may be a RISC system, and may run a variety of operating systems (perhaps HP-UX, LINUX, UNIX, MICROSOFT™ NT, AIX™, or the like). The processing circuitry 108 may also be provided by devices such as Personal Digital Assistants (PDA's), mainframes, telephones, televisions, watches or the like.

The computer 100 also comprises a printer 119 which may be thought of as a printing means which connects to the I/O subsystem 116. The printer 119 provides a printing means and is arranged to print documents 180 therefrom.

It will be appreciated that although reference is made to a memory 114 it is possible that the memory could be provided by a variety of devices. For example, the memory may be provided by a cache memory, a RAM memory, a local mass storage device such as the hard disk 112 (i.e. with the hard drive providing a virtual memory), any of these connected to the processing circuitry 108 over a network connection such as via the transmitting/receiving means 120. However, the processing means 110 can access the memory via the system bus 118, accessing program code to instruct it what steps to perform and also to access the data. The processing means 110 then processes the data as outlined by the program code.

The memory 114 is used to hold instructions that are being executed, such as program code, etc., and contains a program storage portion 150 allocated to program storage. The program storage portion 150 is used to hold program code that can be used to cause the processing means 110 to perform predetermined actions. Although expanded upon hereinafter the program storage portion 150 in particular provides a content item supply means 158, a positioning means 160, a line generator 162, a sub-area creator 164 and an assessment means 166. It will be appreciated that whilst the items discussed in this paragraph, at least, are described as being provided by software, it would be equally possible to provide them in hardware.

The memory 114 also comprises a data storage portion 152 allocated to holding data and in embodiments of the present invention in particular provides a content item store 154 arranged to hold a store of content-items, a candidate layout buffer 156 and one or more electronically stored documents 180 and/or proto-documents. The skilled person will appreciate that a proto-document is a document that is undergoing processing and as such is partially complete.

In some embodiments of the invention a document 180 is created by laying out content-items onto a proto document in order to create the document 180. It will be appreciated that proto document and document will comprise an area on which information can be displayed. Content-items can be photographs, drawings, charts, graphs or any other item that can be placed in a document. In some embodiments passages of text can be considered as content-items. In other embodiments passages of text are not considered as content-items as it can be undesirable to change the size of passages of text and create inconsistencies between the sizes of the fonts for different passages of text.

In the embodiment being described the memory 112, 114 comprises a content-item store 154 which holds a plurality of content items for placing on a document. The memory 112, 114 also comprises the content-item supply means 158 which is arranged to retrieve content-items from the content-item store 154 and supply the retrieved content-items for further processing.

When a document is being created, content-items may primarily be considered as being of two types: fixed content-items and dynamic content-items. Fixed content items are those that are required, by design rules being used to create that particular document (branding, styles, document contents, etc.), to be in a fixed place within the document (i.e. to be placed at a predetermined fixed location). For example, one content-item may comprise a company logo and it may be required by the design rules to place the company logo 600 in a predetermined region of the first page of the document (as for example in FIG. 6).

Documents that are tailored to a specific reader, generally as part of a large print run, may be referred to in the art as highly personalized documents. Such documents tailored to a specific reader will generally comprise fixed content items which will be present in each edition of a document (wherein edition is used to refer to a version of the document that is tailored to a specific reader). For example, and referring to sales information for houses, every reader may get an individual selection of houses for sale in their edition, but a title such as “location of houses”, or the like, will generally be preserved across each edition. The same may apply for the agency/agent contact details, company logo, etc. In another example the document provides a holiday brochure and whilst every reader receives a personal selection of hotels within any one resort, the overall run of brochures may share the same resort description. Thus, the resort description provides a fixed content-item. Whilst there is a certain flexibility of what content-items should occupy what position, the fixed content-elements and their positions should remain unaltered.

Dynamic content-items are content-items selected for each edition of a document. The content, size, shape, colour and the like are likely to vary (often significantly) from one edition to another.

There is what may be thought of as a third type of content-item: content-items that change their content from one edition to another whilst preserving the same position. Taking the previous example of a holiday brochure:
[1] A name of a resort is a fixed content-item—it stays unchanged in each edition of the document.
[2] The selection of hotels is a dynamic content-item—it is individual for each edition of the document.
[3] A table of prices is an example of the third type of content-item which changes its content depending of what hotel is actually selected, but is placed at the same position within each edition of the document (lower right corner of a page, for example). The third type of content items may be referred to as pseudo-fixed content items.

Another example of a pseudo-fixed content item is one that it is required to place at the focal point of a page of the document; i.e. the most important/relevant content item for that particular edition of the document should be placed at the focal point. The most relevant content-item will change from reader to reader (and also therefore from edition to edition), but in some embodiments once it has been specified, it will claim the same position within the document. When considering a single page the focal point is generally considered to be a central region of the page roughly 7/11^{th} of the distance from the bottom to the top of a page.

In embodiments of the invention fixed content-items and/or pseudo-fixed content-items may be placed within the document before dynamic content-items. Dynamic content-items are those that do not have to be placed at a predetermined fixed location. The remaining area (i.e. the area remaining from the area once fixed and/or pseudo-fixed content-items have been placed) may then be assessed in order to determine how the dynamic content-items may be fitted therein. It is expected that the remaining area is to be non-rectangular non-convex domain with possible holes therein. The skilled person will appreciate that in a convex domain a straight line may be drawn between any two points in the domain without the line passing outside the domain. Therefore, it will also be appreciated that in a non-convex domain a line drawn between two points, each lying inside the domain, may lie, at least along parts of its length, outside the domain.

Thus, although the remaining area may have an asymmetric and irregular shape, it is still desired for the document 180 that is produced to adhere to aesthetic design criteria and generally ‘look good’. In other words methods used to develop the document 180 should generally not arrange the dynamic content-items in the remaining area in a haphazard manner.

One way to promote pleasing appearance is to break the remaining area (which may be the whole document if there are no fixed and/or pseudo-fixed content-items) into rectangular containers and then to pack the dynamic content-items into the rectangular containers. This helps to ensure that dynamic content-items will be aligned with fixed and/or pseudo-fixed content-items, that a document does not “visually split into parts” and looks like a whole composition. Further potential advantages are that it provides a plan view (i.e. a bird's eye view) structure of a page, helps to enforce grouping of content-items that it is desired to group and helps to provide a natural sequence for the eye of a reader to follow.

Such containers are a convenient way of referring to what are sub-areas of the area and/or the remaining area. This approach has the advantage that it incorporates various basic design principles. One such design principle is visual alignment. Since the containers are rectangular, content-items inside the container are likely to be aligned either horizontally, or vertically, or both. Moreover, since separate containers are rectangles having parallel sides, each container may be aligned with neighbouring containers, fixed and/or pseudo fixed content-items and borders of the document. The skilled person will appreciate that other shapes of containers may be equally possible although square and/or rectangular containers are the preferred embodiment. For example the containers may be any of the following non exhaustive list: triangular, pentagonal, hexagonal or any other suitable shape.

Another design principle is grouping. Content-items may be grouped automatically by forcing content-items that ‘go together’ to be placed in the same container. For example, in a kitchen catalogue, we may position all kettles in one container and all toasters in another container.

A third design principle is referred to as ‘sequence’. Often, a container may take the form of a column or row (i.e. having shape either a tall and narrow, or short and wide); this provides a natural trajectory for the eye to follow, which is advantageous in relatively crowded catalogue-type environments.

Some embodiments of the invention may consider the design of a document as a three step process: i. identify the available area on the document and break it into containers; ii. assign and adjust content-items to a container; and iii. determine the layout of content-items within any one container.

In one particular embodiment of the invention stage i. of the method may be broken into sub-steps and summarised as follows:
1. Place fixed and/or pseudo- fixed content-items on a page.
2. Using alignment lines generated from fixed and/or pseudo-fixed content-items, and adding extra alignment lines if necessary, generate a grid. It will be appreciated that some cells of this grid may be occupied by fixed and/or pseudo fixed content-items.
3. Combine cells of the grid into larger containers that later (by other algorithms) will be filled with dynamic content-items.
It will be appreciated that these steps help to provide the advantages discussed above.

In some embodiments the method may allow the dimensions of a container to be adjusted in order that the container may fit the available area. Such a method is exemplified in British patent application No GB 0416638.5 in the name of Hewlett Packard.

A flow chart outlining one possible embodiment for performing step i. (identify the available area on the document and break it into containers) is now described in relation to FIG. 8. The method outlined in relation to FIG. 8 provides a defined collection of sets of containers some of which may be suitable and others of which may not be suitable. Some embodiments of the method may consider all of the sets within the collection. Other embodiments may simply try the first set within the collection, whilst other embodiments may try a predetermined number of sets within the collection.

Step 2 of the method (assign content-items to a container) may be implemented in a number of ways; one approach would be to assign dynamic content-items to containers randomly or systematically. An example of a method for performing this is shown in patent application numbers GB0317303.6 and GB0317300.2 (HP Ref: 200208557 and 200208558) Finally, step 3 may be implemented using different techniques including those taught in co-pending patent U.S. patent application Ser. No. 10/675,724 “Automatic Photo Album Page Layout”, inventor C. Brian Atkins and U.S. Ser. No. 10/675,823 “Single Pass Automatic Photo Album Page Layout” inventor C. Brian Atkins, both filed 30 Sep. 2003. A further example is shown in Application No GB 0416641.9 in the name of Hewlett Packard.

Step 3 could also be accomplished using a serial flow mechanism; in general, content-items displayed in a catalogue do not have any order imposed on them. As a result content-items may be freely shuffled between containers and/or within containers to achieve better fit. Better fit may be judged by better utilisation of white space or other aesthetic criteria. In some embodiments, content-items may have order imposed thereon. For example, they may need to be sorted by price. If such order is imposed then the content-items are sequentially packed forming so called serial-flow.

Turning to FIG. 8, it can be seen that the input to the method are the fixed and/or pseudo-fixed content-items 800 (together with the location within the document at which those fixed and/or pseudo-fixed) and the dimensions for the documents 802. It will be appreciated that if the document contains fixed and/or pseudo-fixed content-items then the dimensions 802 will generally specify the location of those fixed and/or pseudo-fixed content-items.

FIG. 6a shows a blank sheet 604 which provides an area 606 on which content-items can be placed. It will be seen from FIG. 6c that once fixed and/or pseudo-fixed content-items 600, 602 have been placed at their respective predetermined location a remaining area 608 (shown by cross hatching in the Figure) remains into which dynamic content-items may be placed.

An example of a single page document having the two fixed content-items 600, 602 is shown in FIG. 6b. Thus, the data provided as an input would comprise the company logo 600, the reference 602, the dimensions for document including where on the document the fixed content-items 600, 602 should be placed. The fixed content items 600, 602 are retrieved from the content-item store 154 by the content-item supply means 158 and positioned on the sheet 604 by the positioning means 160 provided in the memory 112, 114.

In some embodiments non-rectangular fixed and/or pseudo-fixed content-items (such as both 600 and 602) may be considered as rectangles as shown in FIG. 6c. However, this need not be the case. Once the locations of the fixed and/or pseudo-fixed content-items are know it is possible to determine a maximal set of available containerscells, denoted C*, that forms the basis for creating candidate layouts (804 in FIG. 8) which is shown in FIG. 6d.

One method of determining the maximal set of available cells obtaining a collection of alignment lines which comprises any line that is coincident with the border of a fixed and/or pseudo-fixed content-item and extends across the entire sheet (in this embodiment in either a horizontal or a vertical direction). The memory 112,114 includes a line generator 162 which is arranged to generate such lines. In this case, if we have N content-items, this gives rise to at most 4N alignment lines, which generates a grid with at most (1+2N)² cells. Thus, as can be seen in FIG. 6d there are 2 fixed content-items 600, 602 which gives rise to 6 alignment lines (2 lines from the content item 602 are co-incident with the edge of the document reducing the number of lines from the maximal 4N). The two fixed content-items in FIG. 6d give rise to 11 possible cells.

It will be appreciated that in other embodiments that the lines may not be horizontal or vertical in relation to the sheet 604. However, the lines may be at 90° to one another despite not being horizontal or vertical with respect to the sheet 604. In other embodiments, lines which cross one another may not be at right angles to one another which would result in cells which are not rectangular or square. It will be further appreciated that the lines may be virtual lines and may not actually be created—they may simply exist as guides within the memory 112,114.

The cells generated by this technique (i.e. the grid formed by the crossing lines) may be used individually as containers into which one or more content-items may be placed, or may be combined such that a plurality of cells provide a single container. Considerations for merging cells are considered below. It will be appreciated that both the cells and containers which comprise a plurality of cells may be considered sub-areas.

It will be appreciated that the concept of a grid and of alignment lines have previously been used in the laying out of documents by designers in the publishing industry.

Embodiments of the invention may also introduce further alignment lines over and above those generated by the fixed and/or pseudo-fixed content-items which may be in order to create a greater number and variety of sets of containers. As an example, consider a document which comprises a photo album page in which it is desired to display three birthday party shots, two vacation photos, three picnic photos and three graduation photos. There is a further consideration in that it is desired to position the photos together in their respective groups (i.e. the birthday party photos together, the vacation photos together, etc.). One method to position the photos in this manner would be to consider each of the photos as a content-item and to provide a container for each of the groups. Consider further that there may be only a single fixed and/or pseudo-fixed content-item provided in a corner region of the page so that the maximal set of containers C* only has 3 containers. (If the fixed or pseudo-fixed content item were placed in a centre region of the page then there may be up to 8 containers in the maximal set of containers. The method may therefore introduce further alignment lines which would give a larger C* and thus provide greater flexibility in the positioning of the photos. Thus, it would be possible for methods, including that described in relation to FIG. 8, to increase the number of candidate layouts allowing a broader search for the best possible layout at the cost of increased computation. Indeed, in some embodiments no fixed and/or pseudo-fixed content-items may be present and all the alignment lines added may added to give a larger C* as discussed herein.

We can define the set of cells generated by the alignment lines as C={cᵢ}ᵢ₌₁^{k} and C* is defined as the set of cells in C that is not covered by fixed and/or pseudo-fixed content-items 600, 602.

In step 805 a collection of sets of containers is generated, by the sub-area creator 164, based on the maximal set C* of cells provided step 804 and this method is described in relation to FIGS. 4 and 5. Each node in the tree diagram of FIG. 5 represents a set of containers. The tree shown in FIG. 5 represents the example containers shown in FIG. 4. Initially, the top node 500, or root, is defined to be the set of cells in C*. In this example, this is the set of cells a, b, c, d, e which are shown in FIG. 4. The remaining nodes may be obtained in a recursive fashion where each additional node is generated from its parent by removing at least a portion of an alignment line causing two cells to merge into a single, larger, cell. The larger cell may provide a container, or may itself be merged. In the present example, only merges that result in a rectangular merged cell are considered. The result of this process are the sets of containers that are formed such that no further portion of an alignment line may be removed to provide a further, larger, rectangular cell. The sub-area creator 164 may be arranged to merge cells in this manner.

Nodes in the tree of FIG. 5 are formed by joining adjacent cells, as shown in FIG. 4. For example, in FIG. 4 it can be seen that cells a and b are joined by a portion of an alignment line 1. Removing line 1 merges cells a and b into a larger cell. Thus node 502 of FIG. 5 represents the resulting set of cells once line 1 has been removed; the 1 at 504 representing the removal of line 1. It will be seen from node 502 that there are now cells a+b, c, d and e with lines 3 and 4 as potential portions of alignment lines to be removed. From node 502 node 506 is created by removing portion of alignment line 3 to provide containers a+b, c+d and e. The remainder of the tree is arrived at in a similar manner. The tree in FIG. 5 has nodes that provide the same sets of containers/cells on more than one occasion. For example node 508 is the same as node 510. The method may fully expand the tree in this manner or may provide additional steps to ensure that a node only appears once.

Considerations which arise in removing portions of an alignment line are now discussed in relation to FIGS. 2 and 3. The cells that are proposed from set 804 may have portions of alignment lines that may be removed. However, in some cases there may be no portions of an alignment line that could be removed and it is convenient to refer to such a case as being ‘irreducible’. In the tree structure of FIG. 5 the leaves of the tree (i.e. nodes 506, 508, 510, 512, 514, 516, 518 and 520) are considered irreducible arrangements of cells.

It will be apparent that while the number of nodes in the tree will be finite, the number of branches that extend from any node of the tree does not decrease monotonically as we move down the tree. For example, considering FIG. 2a when joining cells c₁ and c₂ the number of portions of an alignment line that can be removed remains unchanged because, once they are joined, it becomes possible to remove the line AB. In another example, in FIG. 2b, by joining cells c₅ and c₆ it becomes possible that lines DE or FG could subsequently be removed.

Conversely, it is also apparent that removing one portion of an alignment line may prevent other portions of an alignment line that could previously have been removed from being removed. See for example FIG. 3a in which by joining cells c₈ and c₉ subsequently prevents the line HI from being removed since the cell that would remain would be non-rectangular. Another example is shown in FIG. 3b in which by joining cells c₁₂ and c₁₃, portions of alignment lines JK and LM are subsequently no longer removable.

Although the tree illustrated in FIG. 5 shows an exhaustive collection of sets of containers, a number of strategies may be employed where only a subset of the collection of possible sets of containers is considered for filling with content-items. For example, only a specific sequence of containers in which the portion of an alignment line to be removed is selected on the basis the smallest existing cell being removed by the removal of that line may be put forward. As another example, only sets of containers that are irreducible may be considered by the method. As yet another example, it may be possible that every possible set of containers is put forward to step 806 of the method. As mentioned above, the tree shown in FIG. 5 contains duplicates which may be removed so that a unique set of containers can be put forward to step 806 of the method. A depth first search through the tree may be a suitable mechanism for searching for duplicates.

Returning to FIG. 8, as step 806, the next step is to generate a sequence of candidate layouts for the dynamic content-items that are to be added to the document. That is the remaining data that is not provided by the fixed and/or pseudo-fixed content-items 600, 602 already positioned.

At step 806 a first candidate set of containers denoted Kᵢ is identified. i is a counter that is used to identify the set of containers that has been generated and is initially set at 0. It will be appreciated that Kᵢ represents one particular set of containers within the collection of sets of containers and does not represent a complete layout. As discussed above the method may consider each of the sets of containers within the collection of containers, and this may be the preferred option, but the method may also stop at other end points. For example, the method may stop once a suitable set of containers has been identified or once a predetermined number of sets of containers have been identified.

At step 810 a preliminary determination as to whether Kᵢ is likely to lead to a reasonable candidate layout. For example, a user of the embodiment described in relation to FIG. 8, may dictate that no container should be smaller than a predetermined area (because, as such, it may not be large enough to hold any content-items at all). The user may make such specifications through the use of user preferences 168 stored in the memory 112, 114. The assessment means 166 may assess the containers to ascertain whether the proposed containers meet the user preferences 168.

Alternatively, or additionally, preferences (which may be user 168, style, or the like) or preliminary analysis of the dynamic content-items may dictate that no rectangle in the set of containers Kᵢ should have an aspect ratio smaller or greater than a threshold value because any such container would be too short/wide or tall/narrow to contain a content-item from the content items that is desired to place on the document or may simply look unacceptable.

It will be seen that the dynamic content-items 808 are provided as an input to step 810 allowing them to be assessed, by the assessment means 166, in step 810. In such instances of Kᵢ it would save processing time by not considering that candidate layout further so that the result of step 810 is negative and the process flow passes to step 812 for the generation of a further set of containers Kᵢ.

Examples of some of the sets of containers that could be produced, the sub-area generator 164, from the alignment lines of shown in FIG. 6 are shown in FIG. 7. It will be appreciated that in FIG. 7 some of the cells proposed in FIG. 6d have been merged to provide the sets of containers shown in FIG. 7. Whilst FIGS. 7e to 7i produce viable sets of containers the method, in this example, has rejected the sets of containers shown in FIGS. 7a to 7d.

The reasons behind this may for example as follows. Looking at FIG. 7a it may be determined that container 700 has an area below a threshold limit and should therefore be rejected. Looking at FIG. 7b it may be determined that the majority of the containers in that set (702, 704, 706, 708) are of a tall and narrow nature (thus providing a high aspect ratio—height/width) and thus an aesthetic design rule requiring that the containers have an average aspect ratio below a predetermined value has been broken or may just not enough variety on a page—i.e. the page may be thought of as being too boring. Looking at FIG. 7c the container 710 is determined to have too high an aspect ratio and therefore the set is rejected. Looking at FIG. 7d is again determined that the average aspect ratio is too high (because of containers 712 and 714 being of a tall and narrow nature).

Without referring to the Figures the a non-exhaustive list of possible reasons for rejecting a set of containers (i.e. a candidate layout) may be as follows:
At least one of containers in the set is too small/big/wide/narrow or its aspect ratio is too high/small.
The width of at least one of the containers may be insufficient to hold text of a given font or other content-item (a font imposes minimal line width for readability). The set of containers has unacceptable aesthetic, stylistic, branding or unacceptable feature. For example, an otherwise good set of containers may be rejected because it has n containers while branding (all editions of the catalogues from this particular shop) requires no more than n−1.
A dynamic content-item required by the rules being used for an edition of the document cannot be accommodated in any of the containers proposed by the set of containers.
If the container is to be filled with text then the text may be too coarse or the container may be too shallow to accommodate the text. Conversely, there may not be enough text to fill the container, etc.

A set of containers may be rejected before or after an attempt to place content-items within the set of containers has been made. It will be appreciated from the foregoing that this occurs in steps ii and iii of the method outlined herein. It will be appreciated that some of the reasons that a set of containers may be rejected discussed in the previous paragraph may occur before an attempt is made to place content-items whilst other of the reasons will occur afterwards. In some embodiments of the invention any rejected set of containers is recorded together with the reason(s) for the rejection and any newly formed set of containers is checked against this recorded information. It will be appreciated that this is advantageous because it can help to reduce the processing time required to check sets of containers. For example, when the first set of containers for a particular page is formed, the minimum size of container required to fit all content-items for that edition of the document may be unknown, but as soon as the first attempt to pack has failed due to a container being too small, then the rest of formed sets of containers may be checked to see that they have at least one sufficiently large container. As such the method may become more efficient.

If the set of containers is not rejected, the process flow moves onto step 814 in which an attempt is made to fit the dynamic content-items in to the containers provided by the set of containers Kᵢ which yields a candidate layout.

In step 816 a score is computed for the candidate layout by the assessment means 166. Although there are many metrics that may be used to compute this score one possible mechanism would be to compute the free area coverage by dynamic content-items, or the fraction of free area covered by dynamic content-items. In this example, a higher free area coverage corresponds to a better layout because it tends to suggest that the free area is being used more efficiently by better accommodating the shapes and sizes of the dynamic content-items. In line with aesthetic rules there may be both minimum and maximum free area that is allowable; it will be appreciated that if there is not enough free area then the resulting document 180 may appear overcrowded. (The skilled person will appreciate the aesthetic principle of density: for a particular document type and style this defines the acceptable amount of empty space within certain limits. Low cost documents (e.g. Yellow pages) tend to utilize up to 90% of available space. Expensive magazines can have up to 50% of their area unoccupied on some pages.

In step 818 a determination is made, by the assessment means 166, as to whether this is the best candidate layout that has so far been produced. If it is then the layout is preserved in step 820 by storing the candidate layout in a buffer 156, otherwise the method assesses whether it should continue in step 822.

If it is determined that the method should continue the method repeats and a further Kᵢ is considered with i being incremented by one in step 812. As discussed above there are many strategies for determining a candidate layout. For example all sets of containers with the collection of sets of containers C* are to be assessed and this has not yet occurred therefore i should be incremented; the score achieved in step 818 is not sufficiently high so a further layout should be considered; not enough layouts have been considered and therefore further layouts should be considered, or the like.

Once it is determined in step 822 that there is no need to continue the candidate layout held in the buffer 156 is used as the best candidate layout determined by the method as in step 824.

Once a candidate layout has been determined by the method then it is printed by the printing means 119.

An advantage of some of the embodiments discussed herein is that they provide a mechanism for reducing the search space in order that a finite search may be performed if it is desired to locate all solutions; i.e. the solutions to the search are finite rather than infinite. Some of the embodiments of the method consider only aesthetically pleasing layouts rather than checking all possible layouts and then rejecting aesthetically unacceptable layouts. Thus, the time taken to find an acceptable solution to the layout of the content-items within the area may well be reduced when the method is run on the same hardware when compared to prior art methods.

1. A method of arranging a plurality of content-items in a designated area, the method comprising:
a. positioning within the area any content-items for which there is a pre-determined requirement for placement at a specified location within the area;
b. subsequently generating one or more lines within the remaining area;
c. creating at least one set of sub-areas from the lines;
d. evuating whether at least one set of sub-areas is a suitable solution to laying out the content-items on the document; and
e. repeating steps c. and d. until a suitable layout has been achieved.

2. A method according to claim 1 in which step c of the method considers whether sub-areas created by the addition of the lines can be merged in order to generate a set of sub-areas suitable for receiving one or more content-items.

3. A method according to claim 2 in which step c of the method proposes a different set of sub-areas to step d of the method in each iteration of the method.

4. A method according to claim 1 in which the lines generated in step b extrapolate boundaries of any content-items that have been positioned in step a.

5. A method according to claim 1 in which the method comprises a further step, between steps c and d, comprising adding one or more content-items to a sub-area.

6. A method according to claim 5 in which the method, in step d, makes an assessment of whether the position of the content-items within the sub-areas provides a suitable solution to laying out the content-items on the document.

7. A method according to claim 1 in which the sub-areas are limited to being one of rectangular and square.

8. A method according to claim 1 in which the method is stopped at step e at any of the following end points: when a single solution to laying out the document has been located; when all of the possible variations of the sets of sub-areas generated by the addition of the one or more lines in step b have been assessed; when a predetermined number of solutions to laying out the document have been located.

9. A method according to claim 1 in which the content-items comprise any of the following: a graphic image, text, a combination of a text and graphic image.

10. A document creation system arranged to layout a plurality of content-items on an electronically stored document having an area on which information should be displayed, the system comprising a content-item supply means arranged to provide content-items containing displayable information, a positioning means arranged to position any content-items for which there is a requirement for placement at a predetermined fixed location within the area, a line generator arranged to generate one or more lines within the remaining area once any fixed content items have been placed in the area, a sub-area creator arranged to create at least one set of sub-areas from the lines generated by the line generator and an assessment means arranged to assess whether at least one set of sub-areas is a suitable solution to laying out the content-items on the document.

11. A system according to claim 10 in which the positioning means is arranged to place content-items in sub-areas within the set of sub-areas.

12. A system according to claim 10 in which the assessment means is arranged to assess both the set of sub-areas and also the placement of the content-items within the sub-areas.

13. A system according to claim 10 in which the line generator is arranged to generate lines such the remaining area is divided into one or both of squares and rectangles.

14. A system according to claim 10 which is arranged to iteratively cause the sub-area creator to create sets of sub-areas from the lines generated by the line generator.

15. A system according to claim 10 which further comprises a printing means arranged to print the document once the assessment means deems that a suitable solution has been found.

16. A program for laying out a plurality of content-items on an electronically stored document which provides an area onto which the content-items are to be placed, the program comprising code for:
a. positioning within the area any content-items for which there is a requirement for placement at a predetermined location within the area;
b. generating one or more lines within the remaining area once any such fixed content-items have been placed in the area;
c. creating at least one set of sub-areas from the lines that have been generated within the remaining area;
d. assessing whether at least one set of sub-areas is a suitable solution to laying out the content-items on the document; and
e. repeating steps c. and d. until a suitable layout has been achieved.

17. A machine readable medium containing instructions which when read by a machine cause that machine to perform the method of claim 1.

18. A machine readable medium containing instructions which when read by a machine cause that machine to function as the system of claim 10.

19. A machine readable medium containing instructions which provide the program of claim 16.
